(19) United States
(12) Patent Application Publication
(10) Pub. No.: US 2002/0047772 A1
(43) Pub. Date: Apr. 25, 2002

(54) Electrical-resistant via hole and process of fabricating the same

(76) Inventors: Huey-Ru Chang, Hsinchu (TW); Min-Lin Lee, Hsinchu (TW); Ted C. Ho, Hsinchu (TW)

Correspondence Address: RABIN & CHAMPAGNE, PC, 1101 14TH STREET, NW, SUITE 500, WASHINGTON, DC, 20005, US

(21) Appl. No.: 09/909,822

(22) Filed: Jul. 23, 2001

(30) Foreign Application Priority Data
Oct. 19, 2000 (TW) 089121879

(51) Int. Cl. H01C 1/012

(52) U.S. Cl. 338/308

(57) ABSTRACT

An electrical-resistant via hole structure used in a carrier is disclosed. The electrical-resistant via hole includes a via hole and electrical-resistant material. The via hole is in the carrier and extends along a first direction. The electrical-resistant material is placed into the via hole and contacts with first and second conductors. The assembly consisting of a first conductor, electrical-resistant material, and second conductor composes a resistor. The electrical-resistant via hole of the invention needs less area and reduces the size of PCBs.

This application incorporates by reference Taiwanese application Ser. No. 089121879, Filed Oct. 19, 2000.

### BACKGROUND OF THE INVENTION

1. Field of the Invention

The invention relates in general to a structure of a via hole, and more particularly to an electrical-resistant via hole, which can be applied as a resistor on Carriers.

2. Description of the Related Art

Circuit design is aimed to be smaller and lighter, which can be achieved by the development and progress of the IC (Integrated Circuit) integration and fabrication and advances of device package. Resistors are one of the basic and necessary electronic components. Therefore, reducing the area occupied by resistors is helpful for size minimization of circuits.

Conventionally, the resistor is fixed on the circuit board by Surface Mounted Technique (SMT), as shown in FIG. 1. The resistor 102 is fixed to the pad 104 and the pad 104 is fixed on the circuit board (not shown). Trace 106 is utilized to connect the pad 104 with the via hole 108 on the circuit board. However, the resistor 102, fixed by SMT, occupies a large surface area, which is against the aim of size shrinking. Therefore, invention of a resistor needing a smaller area on a circuit board is important.

FIG. 2 shows the top view of the conventional planar resistor within the circuit board. A thin-film resistor and an electrical-resistant metal-film produced by electrodeposition are respectively disclosed in U.S. Pat. Nos. 5,169,493 and 5,243,320. Both are planar resistors. In FIG. 2, the planar resistor 204 is formed on the substrate 202 and contacted with conductors 206 and 208. The planar resistor can be built in inner layers. However, the large surface area occupied by planar resistors may increase the number of layers of a circuit board. This is not acceptable for some Printed Circuit Boards (PCBs) with high device density.

### SUMMARY OF THE INVENTION

It is therefore an object of the invention to provide a via hole used in a carrier, by filling a resistant material into the via hole to form an electrical-resistor via hole structure. The electrical-resistant via hole, as a resistor in a PCB, has a smaller horizontal surface as well as requiring less layers. Therefore, using the resistant via hole structure reduces the size of a PCB.

It is therefore an object of the invention to provide a via hole used in a carrier, wherein the carrier is a printed circuit board (PCB), an Integrated Circuit (IC) socket, an adaptor, a connector, or a heat sink. The resistant via hole includes a via hole and electrical-resistant material. The via hole is in a carrier and extends along the first direction and the electrical-resistant material is filled in the via hole. The electrical-resistant material is contacted with a first and second conductor to act as a resistor.

It is therefore a further object of the invention to provide a method of manufacturing an electrical-resistant via hole. First, the first hole is formed in a carrier. An electrical-resistant material is then filled into the hole. Next, conductor one and conductor two respectively are formed on top and bottom of the carrier. The conductors one and two are connected with the electrical-resistant material.

### BRIEF DESCRIPTION OF THE DRAWINGS

Other objects, features, and advantages of the invention will become apparent from the following detailed description of the preferred but non-limiting embodiments. The description is made with reference to the accompanying drawings in which:

FIG. 1 (Prior Art) illustrates the top view of a conventional SMT resistor.

FIG. 2 (Prior Art) shows the top view of the conventional planar resistor in a PCB.

FIG. 3 (Prior Art) is the schematic diagram of a resistor.

FIG, 4 (Prior Art) is the general 3-dimensional diagram of a PCB with a via hole;

FIG. 5 shows the three-dimensional drawing of a pillar-shaped resistor.

FIG. 6A shows an electrical-resistant via holes according to a preferred embodiment of the invention.

FIG. 6B shows the equivalent circuit of the electrical-resistant via hole as shown in FIG. 6A.

FIG. 7A to 7D show the proceeding procedures of the electrical-resistant via hole in FIG. 6.

FIG. 8A shows the structure of an electrical-resistant via hole formed between the first and forth substrates on a PCB.

FIG. 8B illustrates the structure of electrical-resistant via hole in between second and third layers of a fourth-layer PCB.

FIG. 9A (Prior Art) shows the top view of the conventional SMD resistor on a layout.

FIG. 9B shows an electrical-resistant via hole of the invention on a layout.

FIG. 10 is the lateral view of a computer system structure, which uses the electrical-resistant via hole of the invention as a resistor.

FIG. 11A is the lateral view of an adaptor, which uses the electrical-resistant via hole of the invention as a resistor.

FIG. 11B is the equivalent circuit of the resistor between the pad 1106 and the pad 1114.

FIG. 12A is the lateral view of another structure of an adaptor, which uses the electrical-resistant via hole of the invention as a resistor.

FIG. 12B is the equivalent circuit between pad 1204, pad 1208, and conductor 1218 of FIG. 12A.

FIG. 13A is the lateral view of another structure of an adaptor, which uses the electrical-resistant via hole of the invention as a resistor.

FIG. 13B is the equivalent circuit between the pad 1310, pad 1312, and conductor 1320 of FIG. 13A.

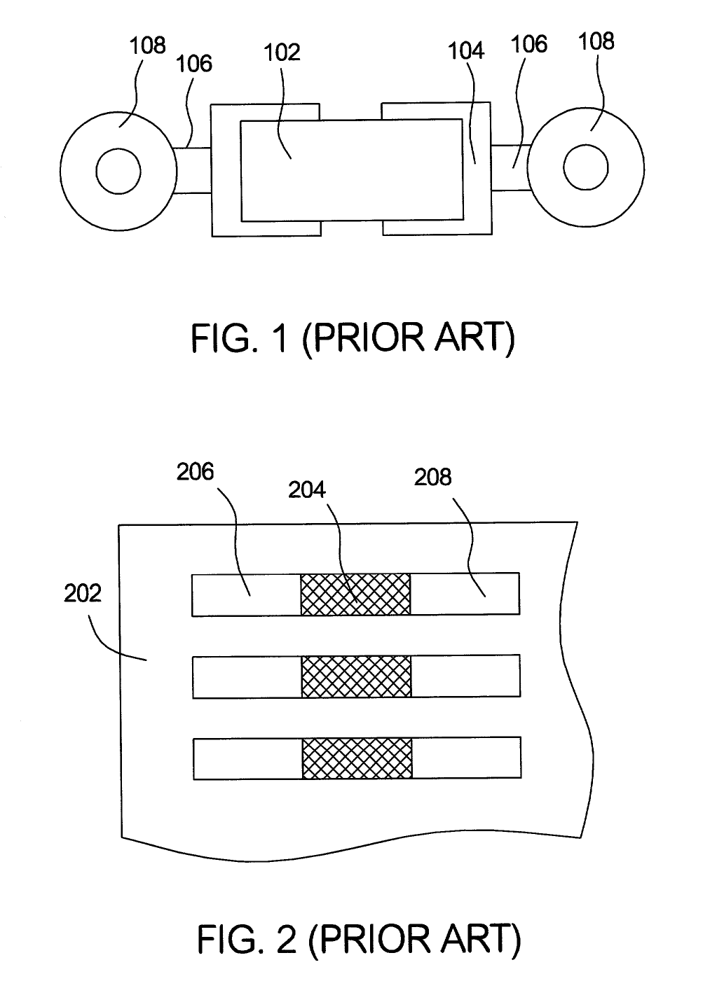

### DESCRIPTION OF THE PREFERRED EMBODIMENT

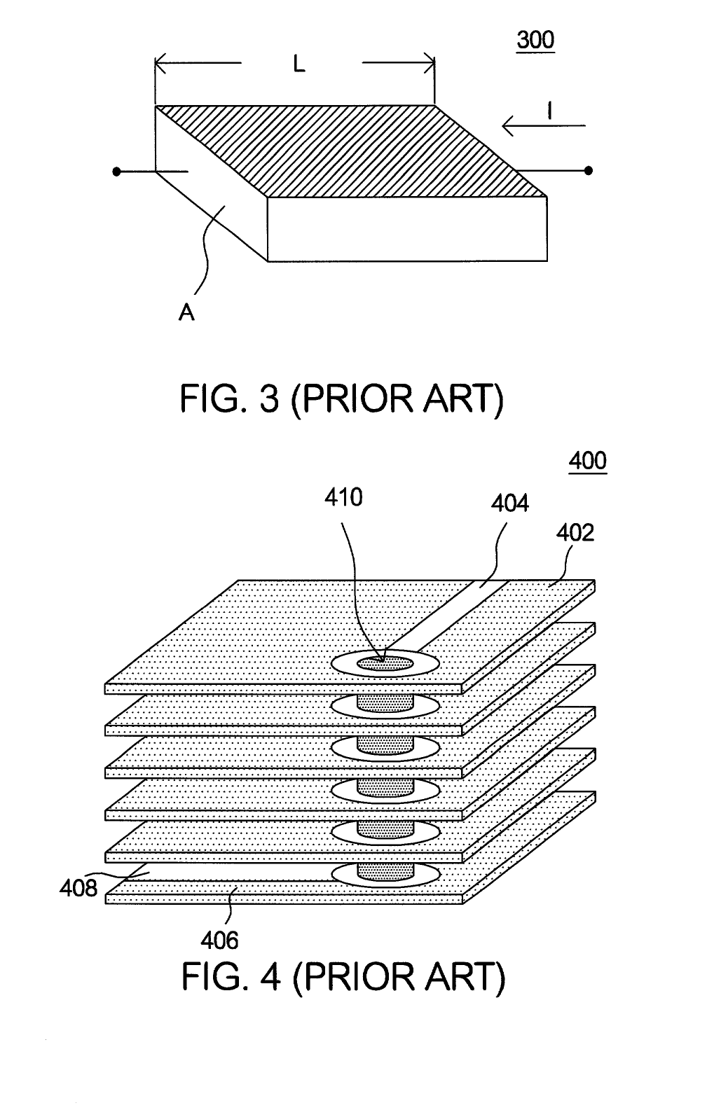

A resistor is an electronic component mainly used to resist electrical current and transfer electricity to heat. Any electronics having these functions can be used as a resistor. FIG. 3 shows that the resistance R of the resistor 300 is proportional to both the resistivity σ and the length L of the resistor 300, and is inverse proportional to the cross-section area A of resistor 300. It means the longer the length L, the higher the resistance R, while increasing the area A reduces the value of resistance R.

FIG. 4 shows a 3-dimensional drawing of a general PCB with via holes. The PCB 400 contains numerous layers, e.g. layer 402 and layer 406. The trace 404 on the layer 402 is connected with trace 408 by via hole 410. Therefore, signals can be transferred from layer 402 to layer 406. Furthermore, the via hole 410 has more functions than signal transferring according to a preferred embodiment of the invention.

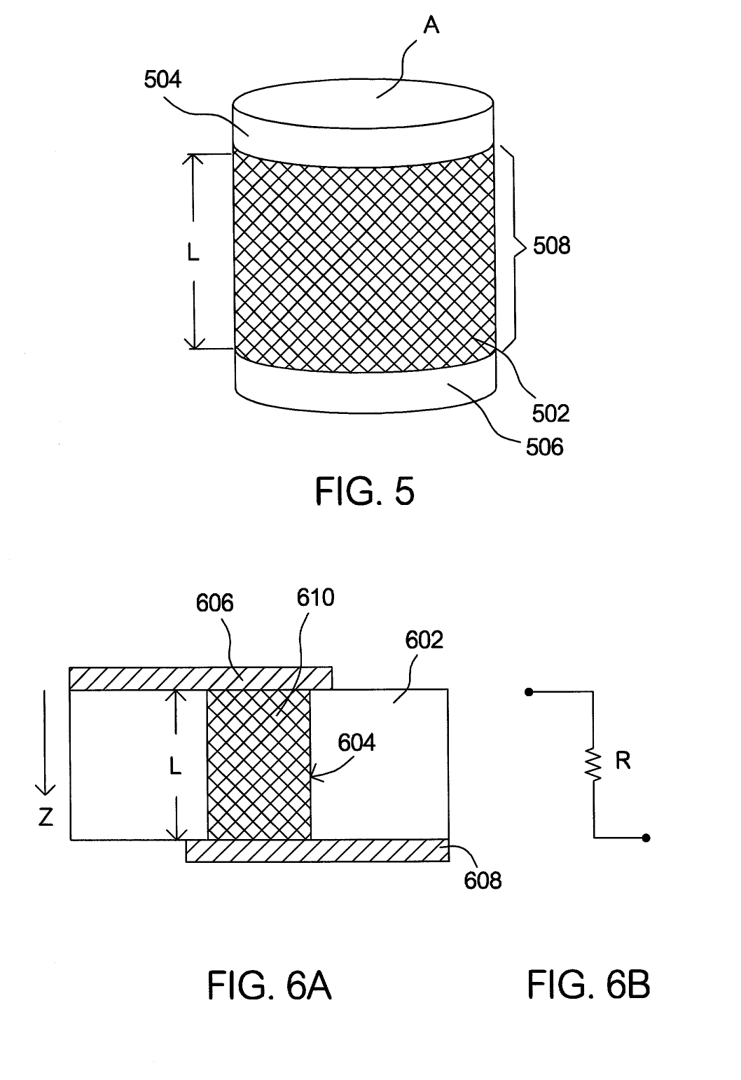

FIG. 5 is a 3-dimentional drawing of a pillar-shaped resistor. The resistor 508 with cross-section A and length L is formed by connecting conductor 504 at one end of the electrical-resistant material 502 and conductor 506 at the other end. The cross section of resistor 508 can be shaped in any configuration as needed. The resistance of resistor 508 is proportional to both the resistivity σ of electrical-resistant material 502 and the length of resistor 508, while inversely proportional to the cross section A of resistor 508.

In FIG. 6, the electrical-resistant via hole of the invention is formed by utilizing the resistor 508 in FIG. 5 within the via hole 410 in FIG. 4. FIG. 6A shows the electrical-resistant via hole according to a preferred embodiment of the invention. Via hole 604 is within substrate 602 and extends along the first direction. The first direction is the direction perpendicular to the surface of the substrate 602, e.g. the Z-direction. The cross section perpendicular to the Z-direction of the electrical-resistant via hole can be shaped as any configuration, for example, round, ellipse, and rectangularity etc. . . . Electrical-resistant material 610 is placed into the via hole 604 and connects with conductors 606 and 608. The material 608 is resistant to electrical current; therefore, this set can be used as a resistor. The equivalent circuit is shown in FIG. 6B. The resistance R is proportional to the resistivity σ of electrical-resistant material 610 and the length of via hole 604 and is inverse proportional to the cross section A of via hole 604. Conductor 606 and 608 are conductive traces and are respectively connected to a voltage source layer, a ground layer or a signal terminal.

The electrical-resistant via hole of the invention acts as a pull down resistor when the conductors 606 and 608 are respectively connected to the signal terminal and the negative voltage. On the other hand, if conductor 606 is connected to a signal terminal and conductor 608 is connected to a power source, the electrical-resistant via hole of the invention acts as a pull up resistor. If the conductors 606 and 608 are connected to different signal terminals, the electrical-resistant via hole of the invention is a serial resistor.

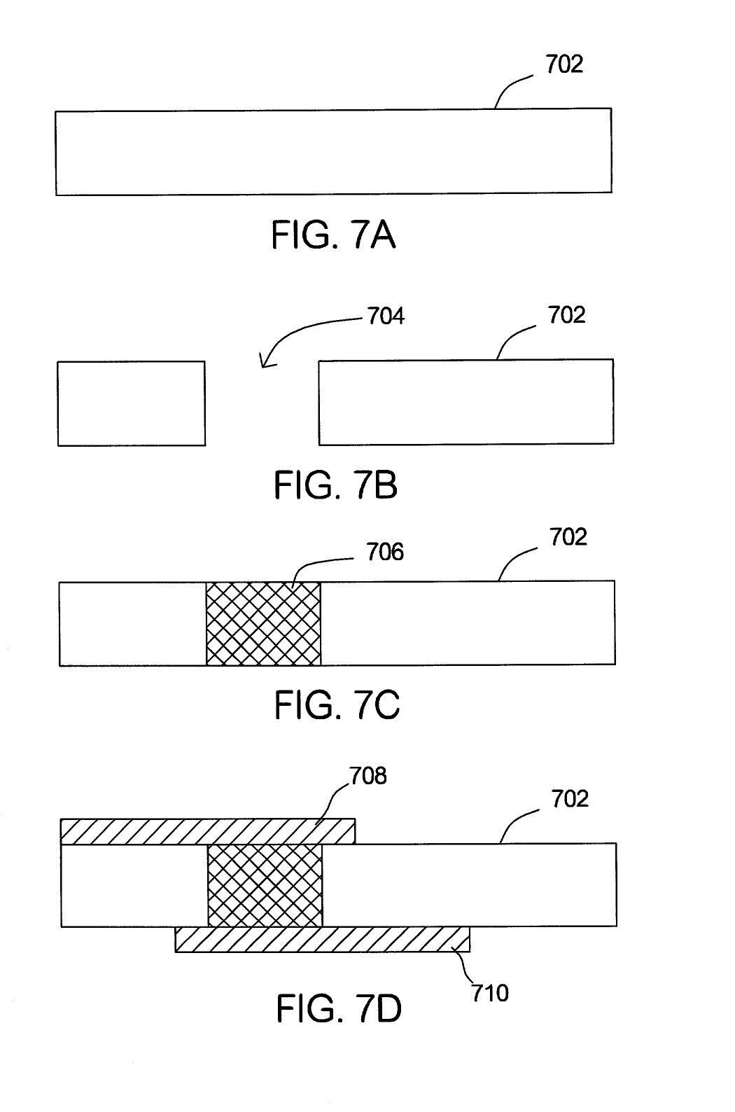

FIG. 7A to 7D illustrate the proceeding procedures of forming the electrical-resistant via hole as shown in FIG. 6. First, form substrate 702 as shown in FIG. 7A. The hole 704 is then formed through the substrate 702, preferably by photo process, punch or drill formations such as mechanically drilling, laser-drilling ablation or plasma ablation, as illustrated in FIG. 7B. Next, as shown in FIG. 7C, the electrical-resistant material 706 is plugged in via hole 704 after which, conductors 708 and 710 are respectively formed on the top and bottom of the substrate 702. The conductors 708 and 710 are preferably formed by laminating or electroplating conductive materials.

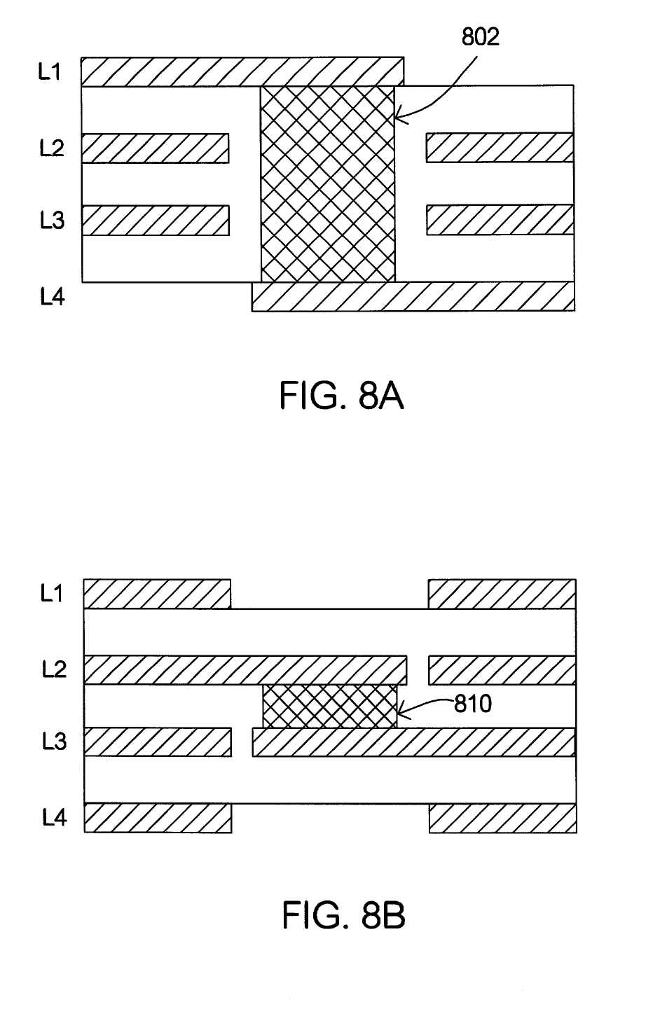

The electrical-resistant via hole formed in only one double side substrate in FIG. 6 and FIG. 7A to 7D is only an example. Actually, the electrical-resistant via hole of the invention can be configured to penetrate through all the substrate layers, or to penetrate through a number of layers of substrate as shown in FIG. 8A and FIG. 8B, respectively. FIG. 8A illustrates the structure of an electrical-resistant via hole penetrating through all the substrate, and FIG. 8B shows the structure of an electrical-resistant via hole formed between layers L2 and L3. In FIG. 8A, the electrical-resistant via hole 810 is formed between signal layers L1 and L4, whilst the electrical-resistant via hole 810 is formed between signal layers L2 and L3 in FIG. 8B.

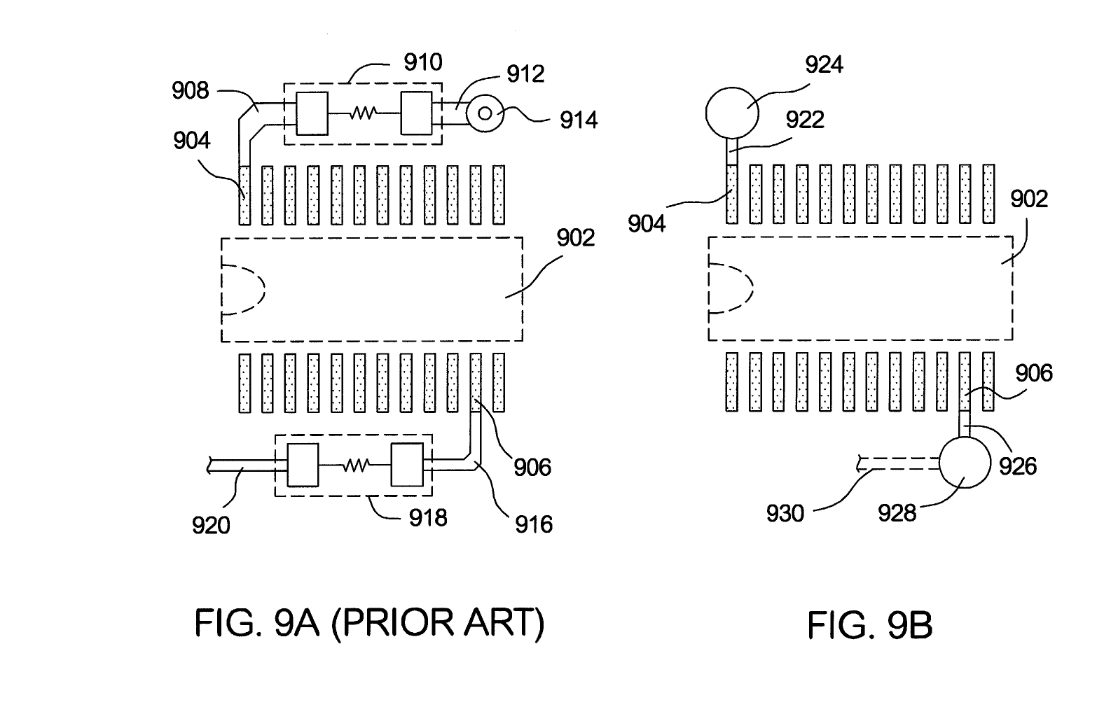

FIG. 9A is the top view of a conventional SMD resistor component. The component 902 placed on a PCB (not illustrated in FIG. 9A) has many pins used to connect to the corresponding pads on the board, e.g. pads 904 and 906. IN FIG. 9A, the component 902 is connected to the convectional SMD resistor 910 by the pad 904 and the conductive trace 908. The other end of the SMD resistor 910 is connected to ground GND by conductive trace 912 and a general via hole 914. Moreover, by using pad 906 and conductive trace 916, component 902 is connected to a convectional SMD resistor 918, which is then connected to a signal terminal by the conductive trace 920.

FIG. 9B is the top view of the electrical-resistant via hole of the invention on a PCB as a resistor. The pad 904 is directly connected to the electrical-resistant via hole of the invention by conductor 924. The other end of the electrical-resistant via hole of the invention 924 is connected to power source. Moreover, by using the conductive trace 926, the pad 906 is connected to an electrical-resistant via hole of the invention 928, which is then connected to a signal terminal by the conductive trace 930.

Comparing FIG. 9A and 9B, it clearly shows that the conventional SMD resistor 910 and 918 are placed on the obverse or inverse sides of the PCB and require a large area. On the contrary, the electrical-resistant via hole 924 and 928 according to a preferred embodiment of the invention requires less area and also reduces the path of the conductive trace. These advantages of the electrical-resistant via hole 924 and 928 of the invention can prevent loss and delay of signals and further reduce the noise level, thus leading to improve electrical properties.

In the above description, the electrical-resistant via hole of the invention is utilized in a PCB. However, PCB is only an example of various carriers. It is apparent that the electrical-resistant via hole according to a preferred embodiment of the invention can also be applied in an IC socket, adaptor, a connector, heat sink or the like aiming to reduce the area and sizes.

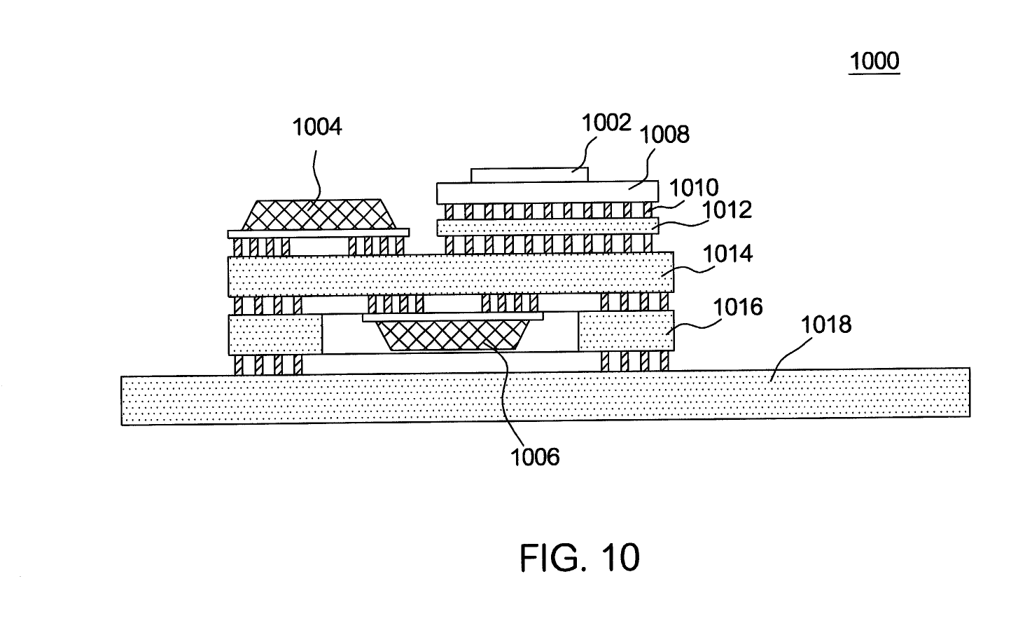

FIG. 10 is the lateral view of the computer system structure, which uses the electrical-resistant via hole of the invention as an adapter. The computer system in FIG. 10 includes Central Process Unit (CPU) 1002, north bridge 1004, and south bridge 1006. CPU 1002 is disposed on the IC socket 1008. The IC socket 1008 is connected to the adaptor 1012 through a number of solder balls 1010. The adaptor 1012, north bridge 1004, and south bridge 1006 are connected to the module board 1014 through solder balls 1010. The standoff board 1016 is connected to the module board 1014 and the carrier board 1018.

The CPU shown in FIG. 10 requires numerous pull up and pull down resistors. The conventional SMD resistors will occupy a very large area on module board 1014 and thus increase the size of a computer system. Using the electrical-resistant via hole of the invention as resistors, this disadvantage can be alleviated. The electrical-resistant via hole can be formed in between adaptor 1012 and module board 1014. In this way, the area of module board 1014 is reduced and thus leading to a reduction in size of the computer system.

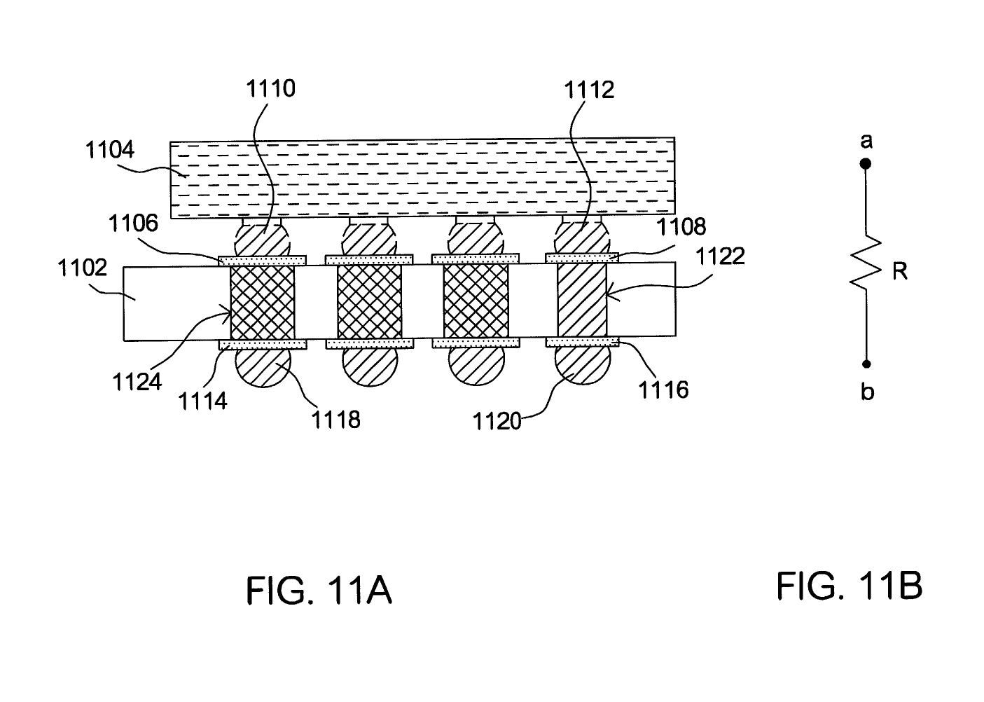

FIG. 11A is the lateral view of an adaptor with the electrical-resistant via hole type resistor according to a preferred embodiment of the invention. A component 1104 is located above the adaptor 1102 and connects with the adaptor 1102. There are a number of pads on the surface of adaptor 1102, e.g. pad 1106 and pad 1108, with each pad having a solder ball on it, e.g. conductive bump 1110 and 1112. There are also a number of pads, underneath the adaptor 1102, e.g. pad 1114 and pad 1116, also each having a solder ball on it, e.g. conductive bump 1118 and 1120. Pads 1108 and 1116 are connected with a general via hole 1122, and pad 1106 and pad 1114 are connected with an electrical-resistant via hole 1124 according to a preferred embodiment of the invention. The equivalent circuit from pad 1106 to pad 1114 is shown in FIG. 11 B. The pads 1106 and 1114 corresponds respectively to points a and b, and the equivalent resistance between pad 1106 and pad 1114 is resistor R.

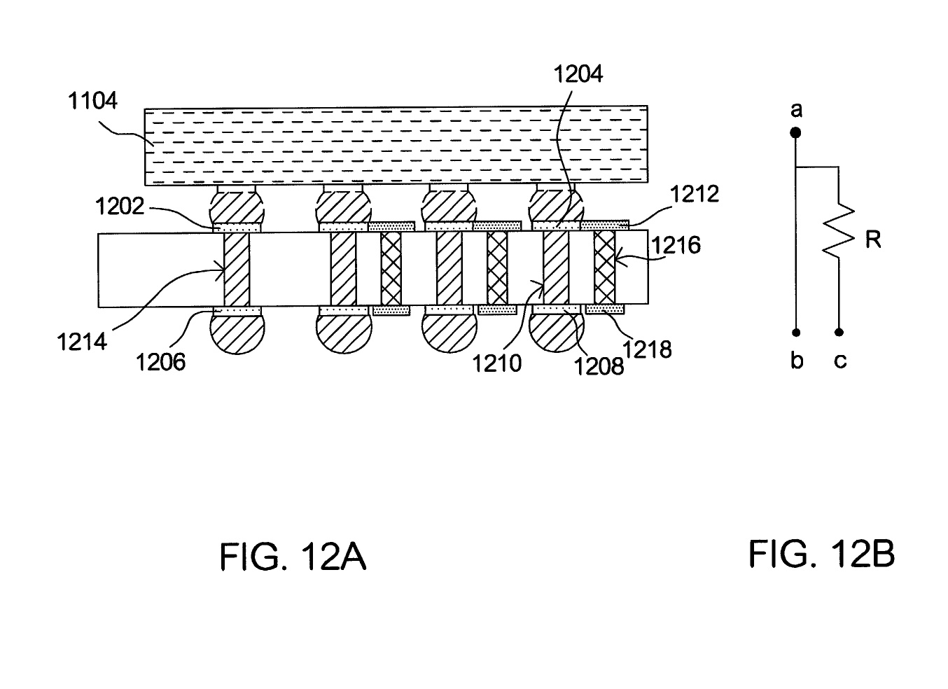

FIG. 12A depicts the lateral view of another type of adaptor with the electrical-resistant via hole type resistor according to a preferred embodiment of the invention. In FIG. 12, pad 1202 and pad 1206 are connected with a general via hole 1214, and pad 1204 and pad 1208 are connected with another general via hole 1210. The pad 1204 is also connected to the electrical-resistant via hole 1216 according to a preferred embodiment of the invention by conductor 1212. The other end of via hole type resistor 1216 is connected to conductor 1218, which can be connected to a negative power source, positive power source, or signal terminal as needed. The equivalent circuit from pad 1204 to pad 1208 and conductor 1218 is shown in FIG. 12B. The pad 1204, pad 1208 and conductor 1218 correspond respectively to points a, b, and c. Pad 1204 is shorted with pad 1208 and is also connected to conductor 1218 by a resistor R, as shown in FIG. 12B.

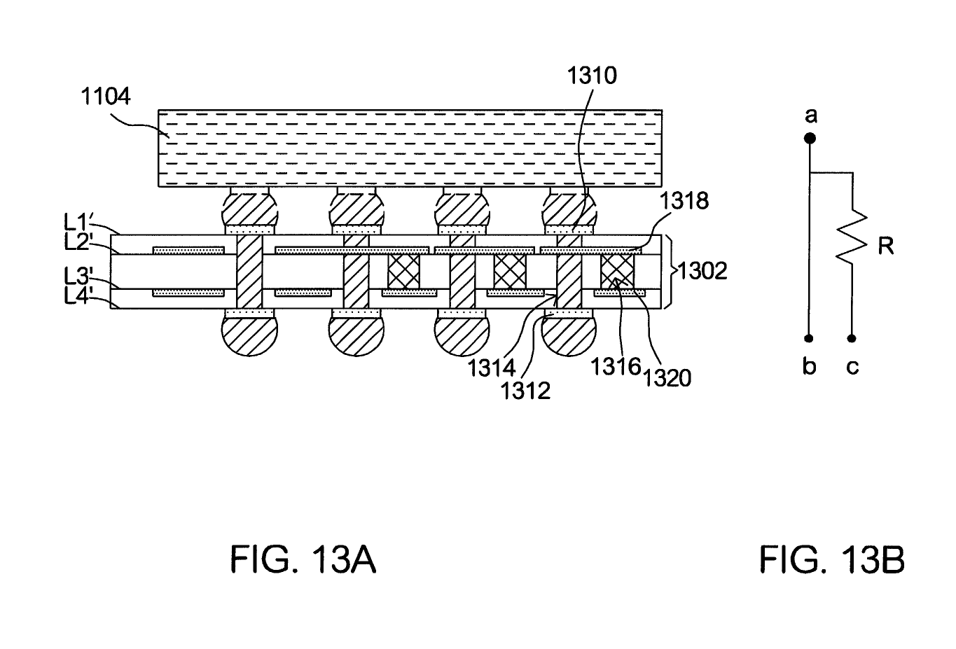

FIG. 13A depicts the lateral view of yet another type of adaptor with the electrical-resistant via hole type resistor according to a preferred embodiment of the invention. Adaptor 1302 is composed by four layers, indicated as layers L1′, L2′, L3′, and L4′. Pad 1310 is connected to pad 1312 by a general via hole 1314. The electrical-resistant via hole type resistors 1316 according to a preferred embodiment of the invention are formed in between signal layer L2′ and L3′. One end of the electrical-resistant via hole type resistors 1316 is connected to a general via hole 1314 by the conductor 1318, and the other end of the resistor 1316 is connected to a positive power source, negative power source, or a signal terminal as desired by the conductor 1320. The equivalent circuit from pad 1310 to pad 1312 and conductor 1320 is shown in FIG. 13B. The pad 1310, pad 1312, and conductor 1320 corresponds respectively to points a, b, and c.

The adaptors shown in FIG. 11A, 12A and 13A may certain have a number of plug-holes, and the component 1104 can be a multi-pin component. These pins are plugged into the holes on an adaptor to fix the component on the adaptor. Furthermore, the connected structure between adaptors and module boards shown in FIG. 11A, 12A, and 13A can be applied in the structure between the chip and adaptor or between the module and adaptor. The structure can also be applied between the heat sink and either the component, chip, or module.

The electrical-resistant via hole according to a preferred embodiment of the invention has the following advantages over the conventional SMD resistor:

(1) The electrical-resistant via hole structure occupies much less surface area than the conventional SMD resistor.

(2) The electrical-resistant via hole of the invention can be used between every two layers of a PCB but the SMD resistor can be only used on the surface of PCB.

(3) The electrical-resistant via hole of the invention can be buried in the substrate but the SMD resistor cannot be applied inside the multi-layer substrate.

(4) The electrical-resistant via hole of the invention effectively shortens the trace path and reduces signal loss and delay, which is superior to the conventional SMD resistor in terms of electrical characteristics.

To sum up, the capacitor or resistor with the via hole structure of the invention has the advantages of occupying much less surface of the substrate or intra-layer surface, being able to be buried in the substrate or other carrier without the need for extra resistors, thus reducing costs in both parts and assembly.

While the invention has been described by way of example and in terms of the preferred embodiment, it is to be understood that the invention is not limited to the disclosed embodiment. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electrical-resistant via hole used in a carrier, comprising:
a via hole in the carrier extending along a first direction; and
an electrical-resistant material in the via hole, wherein the electrical-resistant material respectively connects to a first conductor and a second conductor.

2. The electrical-resistant via hole as claimed in claim 1, wherein the first direction is vertical to a direction along which the carrier extends.

3. The electrical-resistant via hole as claimed in claim 1, wherein the carrier is a printed circuit board (PCB)

4. The electrical-resistant via hole as claimed in claim 1, wherein the carrier is an Integrated Circuit (IC) socket.

5. The electrical-resistant via hole as claimed in claim 1, wherein the carrier is an adaptor.

6. The electrical-resistant via hole as claimed in claim 1, wherein the carrier is a connector.

7. The electrical-resistant via hole as claimed in claim 1, wherein the carrier is a heat sink.

8. The electrical-resistant via hole as claimed in claim 1, wherein the carrier comprises at least one substrate layer and the electrical-resistant via hole penetrates a portion of the substrate layer.

9. The electrical-resistant via hole as claimed in claim 1, wherein the carrier comprises at least one substrate layer and the electrical-resistant via hole penetrates the whole substrate layer.

10. The electrical-resistant via hole as claimed in claim 1, wherein a cross section of the electrical-resistant via hole can be shaped in any configuration.

11. The electrical-resistant via hole as claimed in claim 1, wherein the first conductor is connected to a positive power source and the second conductor is connected to a signal terminal.

12. The electrical-resistant via hole as claimed in claim 1, wherein the first conductor is connected to a negative power source and the second conductor is connected to a signal terminal.

13. The electrical-resistant via hole as claimed in claim 1, wherein the first conductor is connected to a first signal terminal and the second conductor is connected to a second signal terminal.

14. The electrical-resistant via hole as claimed in claim 1, wherein the first conductor is connected to a first power source and the second conductor is connected to a second power source.

15. A method of manufacturing an electrical-resistant via hole, comprising:
(a) forming a via hole in a substrate;
(b) filling an electrical-resistant material in the via hole; and
(c) forming a first conductor and a second conductor respectively on and beneath the substrate, wherein the first conductor and the second conductor are both connected to the electrical-resistant material.

16. The method of manufacturing an electrical-resistant via hole as claimed in claim 15, wherein in said step (a), the via hole is formed by photo formation.

17. The method of manufacturing a electrical-resistant via hole as claimed in claim 15, wherein in said step (a), the via hole is formed by dig formation.

18. The method of manufacturing a multi-layer via hole as claimed in claim 17, wherein the dig formation comprises mechanically drilling.

19. The method of manufacturing a multi-layer via hole as claimed in claim 17, wherein the dig formation comprises punch.

20. The method of manufacturing a multi-layer via hole as claimed in claim 17, wherein the dig formation comprises laser-drilling ablation.

21. The method of manufacturing a multi-layer via hole as claimed in claim 17, wherein the dig formation comprises plasma ablation.

22. The method of manufacturing a multi-layer via hole as claimed in claim 15, wherein the first conductor is formed by laminating or plating.

23. The method of manufacturing a multi-layer via hole as claimed in claim 15, wherein the second conductor is formed by laminating or plating.
